(19) United States
(12) Patent Application Publication
(10) Pub. No.: US 2004/0012656 A1
(43) Pub. Date: Jan. 22, 2004

(54) INK CARTRIDGE HAVING SHIELDED POCKET FOR MEMORY CHIP

(75) Inventor: Diana C. Petranek, Hilton, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/198,511

(22) Filed: Jul. 18, 2002

(51) Int. Cl. B41J 2/175

(52) U.S. Cl. 347/86

(57) ABSTRACT

An ink cartridge includes a housing with an integral pocket, an ink supply bag contained in the housing, and a memory chip supported in a wall opening of the pocket. The housing has an ink blocking shield arranged at a location between the bag and the memory chip to prevent any ink that might leak from the bag from entering the wall opening and contaminating the memory chip.

### CROSS REFERENCE TO RELATED APPLICATIONS

Reference is made to commonly assigned, copending application Ser. No. 09/931,523, entitled INK CARTRIDGE WITH COLOR DISCRIMINATION STRUCTURE and filed Aug. 16, 2001 in the names of Trafton, Newkirk, and Robinson; Ser. No. 09/931,420, entitled INK CARTRIDGE WITH ALIGNMENT FEATURES AND METHOD OF INSERTING CARTRIDGE INTO A PRINTER RECEPTACLE and filed Aug. 16, 2001 in the names of Trafton, Newkirk, Robinson, and Gotham; Ser. No. 09/931,521, entitled INK CARTRIDGE WITH MEMORY CHIP AND METHOD OF ASSEMBLING and filed Aug. 16, 2001 in the names of Trafton, Newkirk, and Robinson; and Ser. No. 09/931,313, entitled INK CARTRIDGE WITH INTERNAL INK BAG AND METHOD OF FILLING and filed Aug. 16, 2001 in the names of Trafton, Farnung, and Petranek.

All of the cross-referenced applications are incorporated into this application.

### FIELD OF THE INVENTION

The invention relates generally to ink cartridges for ink jet printers, and in particular to an ink cartridge that includes a pocket for a memory chip.

### BACKGROUND OF THE INVENTION

The cross-referenced applications filed Aug. 16, 2001, particularly Ser. No. 09/931,521, entitled INK CARTRIDGE WITH MEMORY CHIP AND METHOD OF ASSEMBLING, disclose an ink cartridge that includes a pocket for a memory chip.

The disclosed ink cartridge includes a pair of housing portions with respective pocket portions including wall opening portions, an ink supply bag contained in the housing portions, and a memory chip supported in the wall opening portions. The housing portions mate to form a cartridge housing with the pocket portions forming a single pocket including the wall opening portions forming a single wall opening.

If per chance any ink leaks from an ink supply bag in the cartridge housing, it can enter the wall opening portions and contaminate a memory chip supported in the single pocket.

### SUMMARY OF THE INVENTION

According to one aspect of the invention, an ink cartridge comprising a housing with an integral pocket including a wall opening, an ink supply bag contained in the housing, and a memory chip supported in the wall opening, is characterized in that:

the housing has an ink blocking shield arranged at a location between the bag and the memory chip to prevent any ink that might leak from the bag from entering the wall opening and contaminating the memory chip.

According to another aspect of the invention, a method of assembling an ink cartridge to include a memory chip in a single pocket comprises:

providing a pair of housing portions with respective pocket portions including wall opening portions and with respective ink blocking shield segments extending across the wall opening portions at inner sides of the housing portions;

mating the housing portions to form a cartridge housing with the pocket portions forming a single pocket including the wall opening portions forming a single wall opening and the ink blocking shield segments abutting edge-to-edge to seal the single wall opening; and

including a memory chip in the single pocket as the single pocket is formed.

According to another aspect of the invention, a pair of housing halves for containing an ink supply bag and provided with respective pocket portions including wall opening portions for a memory chip, are characterized in that:

the housing halves have respective ink blocking shield segments that extend across the wall opening portions at inner sides of the housing halves to prevent any ink that might leak from an ink bag contained in the housing halves from entering the wall opening portions and contaminating a memory chip supported in the wall opening portions.

### BRIEF DESCRIPTION OF THE DRAWINGS

FIG. 1 is an exploded perspective view of an ink cartridge according to a preferred embodiment of the invention;

FIGS. 2 and 3 are exploded perspective views of an ink egress snout and a collar in the ink cartridge as shown from opposite views;

FIG. 4 is an enlargement of a bottom portion of the ink cartridge as shown in FIG. 1; and

FIGS. 5 and 6 are exploded perspective views of a memory chip as it is inserted into a pocket in the ink jet cartridge.

### DETAILED DESCRIPTION OF THE INVENTION

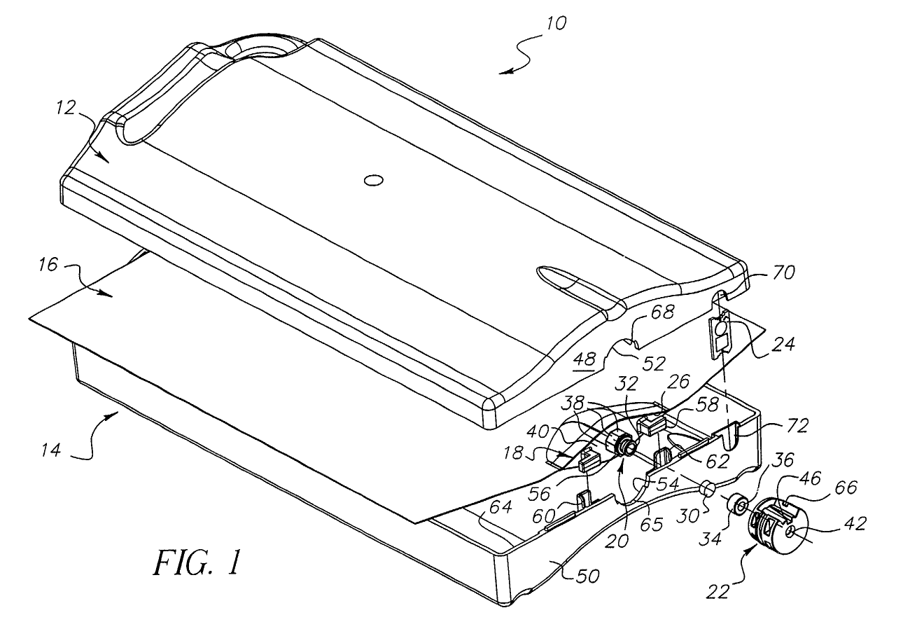

Referring now to the drawings, FIGS. 1-6 show an ink cartridge 10 for an ink jet printer (not shown). The cartridge includes the following components:

a pair of plastic housing halves 12 and 14 that mate or connect to form a cartridge housing;

a disposable flexible ink supply bag 16;

a plastic connector-fitting or fitment 18 having an integral ink egress snout 20 for discharging an ink supply from the bag 16;

a plastic single-part collar 22 for the snout 20, which functions as an ink identifier to identify the ink supply in the bag 16 such as by color or type; and

a memory chip 24.

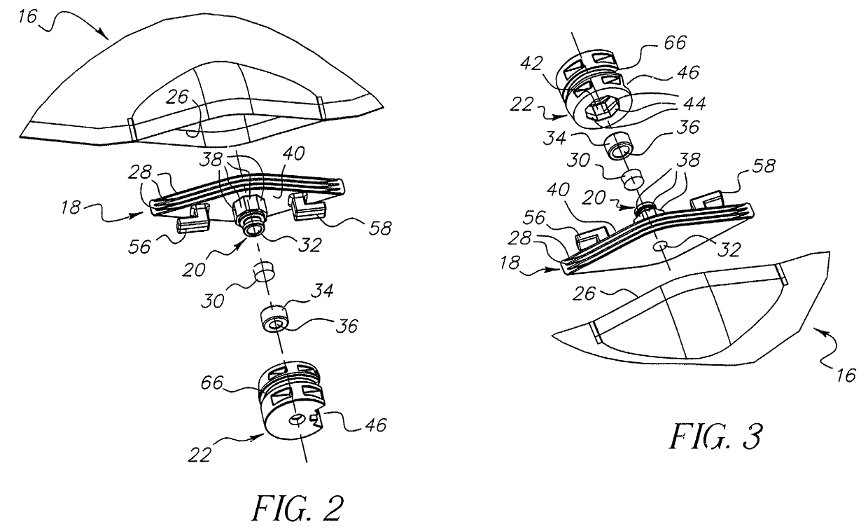

As shown in FIGS. 2 and 3, the fitting 18 is attached via a thermal seal to the bag 16, within an elongate opening 26 in the bag. During the thermal seal of the bag 16 to the fitting 18, a small amount of melted material from the bag flows to between parallel ribs 28 along opposite longitudinal sides of the fitting 18 to provide an essentially leak-proof seal between the bag and the fitting. A rubber septum 30 is tightly inserted into an ink egress opening 32 in the snout 20 to plug the opening. Then, an aluminum or stainless steel cap 34 is press-fitted on the snout 20. The cap 34 partially overlaps the septum 30 to capture the septum, and has a center opening 36 which allows a hollow needle (not shown) to pierce the septum in order to discharge an ink supply from the bag 16 when the cartridge 10 is used in an ink jet printer.

The snout 20 has eight identical outer peripheral surfaces (sides) or facets 38 that project perpendicular from a longitudinal planar face 40 of the fitting 18 to form an octagon. See FIGS. 2 and 3. In a similar sense, the collar 22 has a center opening 42 that is circumscribed by eight identical inner peripheral surfaces (sides) or facets 44 that form an octagon. This mutual or complementary configuration allows the snout 20 to be received in the center opening 42 only when the collar 22 is in any one of eight allowable angular orientations 0° or 360°, 45°, 90°, 135°, 180°, 225°, 270°, and 315°. Preferably, the eight surfaces 44 of the collar 22 are aligned with the eight surfaces 38 of the snout 20 to position the collar relative to the snout in a selected one of the eight orientations. Then, the collar 22 is mated with the snout 20 in the selected orientation. Respective contact between the eight surfaces 38 and the eight surfaces 44 prevents the collar 22 from being rotated about the snout 22 and thus serves to fix the collar in the selected orientation. The selected orientation provides a visible indication that serves to identify the ink supply in the bag 16 such as by color or type.

As described in the cross-referenced applications filed Aug. 16, 2001 and incorporated into this application, the collar 22 has a key slot or keyway 46 that is angular positioned in accordance with the selected orientation of the collar. The hollow needle (not shown) for piercing the septum in order to discharge an ink supply from the bag 16 when the cartridge 10 is used in an ink jet printer is mounted on a key assembly (not shown) having a key tab intended to be received in the key slot 46. The particular orientation of the key assembly must match the selected orientation of the collar 22 in order for the key tab to be received in the key slot 46.

The number of the surfaces 38 of the snout 20 and the number of the surfaces 44 of the collar 22, need not each be eight (although they must be the same number). Preferably, the number of the surfaces 38 of the snout 20 and the number of the surfaces 44 of the collar 22 fall within the range 4-12. All that is necessary is that the number of the surfaces 38 of the snout 20 and the number of the surfaces 44 of the collar 22 form similar complementary polygons.

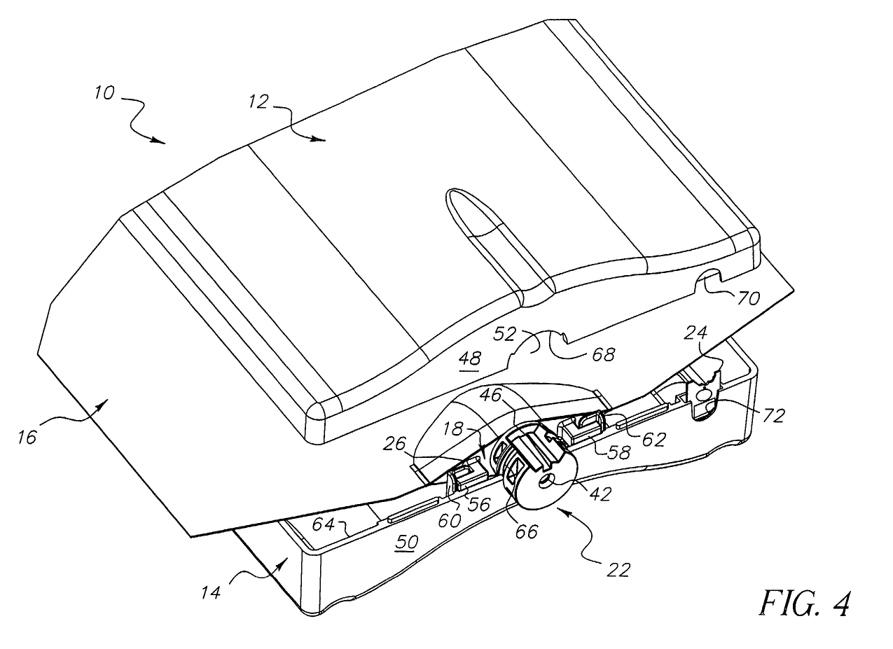

The housing halves 12 and 14 at respective bottom wall portions 48 and 50 have opening halves 52 and 54 that form a single bottom opening when the housing halves are connected together. See FIGS. 1 and 4. The fitting 18 has a pair of L-shaped engageable members or tabs 56 and 58 that project from respective areas of the face 40 (of the fitting) which are spaced from the snout 20. In a similar sense, a pair of L-shaped engageable members or tabs 60 and 62 project from an inner side 64 of the wall portion 50 and are spaced from the opening half 52. The L-shaped engageable members 56 and 58 extend in opposite directions as do the L-shaped engageable members 60 and 62. This complementary arrangement or mutual configuration permits the L-shaped member 56 to engage the L-shaped member 60 and the L-shaped member 58 to engage the L-shaped member 62 when the bag 16 is placed on the housing half 14. The bag 16 is thus secured in place. At the same time as shown in FIG. 4 an edge 65 of the opening half 54 is received in an outer peripheral groove 66 in the collar 22 to support the collar. Then, when the housing half 12 is connected to the housing half 14, an edge 68 of the opening half 52 is received in the groove 66.

When the bag 16 is emptied, it can be removed from the cartridge 10 and disposed of. All that is required is that the housing half 12 be disconnected from the housing half 14 and the L-shaped engageable members 56 and 58 be disengaged from the L-shaped engageable members 60 and 62. The collar 22 can be removed from the snout 20 if it is to be reused.

Other L-shaped engageable members can be provided on the fitting 18 and the housing half 14 in addition to the L-shaped engageable members 56 and 58 and the L-shaped engageable members 60 and 62. Also, it is not necessary that these engageable members be L-shaped. A number of known engagements or interlocks can be used instead, such as pins in holes, etc.

### Pocket for Memory Chip

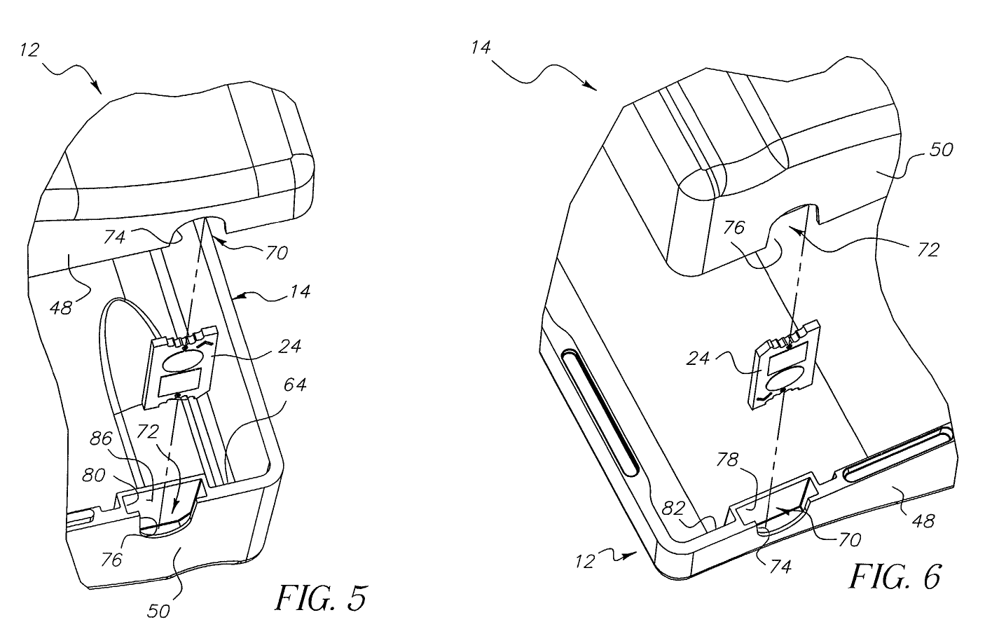

As shown in FIGS. 1 and 4-6, the housing halves 12 and 14 at bottom wall portions 48 and 50 have respective pocket portions 70 and 72 which include slightly smaller and larger wall opening portions 74 and 76 and sleeve or channel portions 78 and 80. Moreover, the bottom wall portion 48 at an inner side 82 and the bottom wall portion 50 at the inner side 64 have respective ink blocking shield segments 84 and 86 that project inwardly of the housing halves 12 and 14 from the inner sides. See FIGS. 5 and 6. The ink blocking shield segment 84 is an integral extension of the inner side 82 and extends across the wall opening portion 74, and the ink blocking shield segment 86 is an integral extension of the inner side 64 and extends across the wall opening portion 76. This is to isolate or seal the wall opening portions 74 and 76 from the interiors of the housing halves 12 and 14.

When the housing halves 12 and 14 are connected together, the memory chip 24 is peripheral-edge supported in the channel portions 78 and 80 to hold the memory chip in the wall opening portions 74 and 76. Also, the pocket portions 70 and 72 combine to form a single pocket including the wall opening portions 74 and 76 combining to form a single wall opening, and the ink blocking shield segments 84 and 86 abut end-to-end to seal the single wall opening. The ink supply bag 16, which is between the housing halves 12 and 14, might per chance leak ink. However, the ink blocking shield segments 84 and 86 which are then abutted end-to-end prevent any ink from entering the wall opening portions 74 and 76 and contaminating the memory chip 24.

The invention has been described in detail with particular reference to certain preferred embodiments thereof, but it will be understood that variations and modifications can be effected within the spirit and scope of the invention.

### Parts List

10. ink cartridge

12. housing half

14. housing half

16. ink bag

18. connector-fitting

20. snout

22. collar

24. memory chip

26. elongate opening

28. ribs

30. septum

32. ink egress opening

34. cap

36. center opening

38. eight surfaces or facets

40. face

42. center opening

44. eight surfaces or facets

46. key slot

48. bottom wall portion

50. bottom wall portion

52. opening half

54. opening half

56. L-shaped engageable member

58. L-shaped engageable member

60. L-shaped engageable member

62. L-shaped engageable member

64. inner side

65. edge

66. groove

68. edge

70. pocket portion

72. pocket portion

74. wall opening portion

76. wall opening portion

78. sleeve or channel portion

80. sleeve or channel portion

82. inner side

84. ink blocking shield segment

86. ink blocking shield segment

What is claimed is:

1. An ink cartridge comprising a housing with an integral pocket including a wall opening, an ink supply bag contained in said housing, and a memory chip supported in said wall opening, is characterized in that:
said housing has an ink blocking shield arranged at a location between said bag and said memory chip to prevent any ink that might leak from said bag from entering said wall opening and contaminating said memory chip.

2. An ink cartridge as recited in claim 1, wherein said wall opening is open at an inner side of said housing, and said shield is located at said inner side to seal said wall opening.

3. An ink cartridge as recited in claim 2, wherein said shield is united with said inner side.

4. An ink cartridge comprising a pair of housing portions with respective pocket portions including wall opening portions, an ink supply bag contained in said housing portions, and a memory chip supported in said wall opening portions, is characterized in that:
said housing portions have respective ink blocking shield segments arranged at individual locations between said bag and said memory chip to prevent any ink that might leak from said bag from entering said wall opening portions and contaminating said memory chip.

5. An ink cartridge as recited in claim 4, wherein said wall opening portions are open at respective inner sides of said housing portions, and said shield segments are located at said inner sides to seal said wall opening portions.

6. An ink cartridge as recited in claim 5, wherein said shield segments are integral extensions of said inner sides.

7. An ink cartridge as recited in claim 6, wherein said shield segments project inwardly of said housing portions from said inner sides.

8. An ink cartridge as recited in claim 4, wherein said housing portions mate to form a cartridge housing, said pocket portions form a single pocket including said wall opening portions forming a single wall opening when said housing portions mate, and said ink blocking shield segments abut edge-to-edge to seal said single wall opening when said housing portions mate.

9. A method of assembling an ink cartridge to include a memory chip in a single pocket, said method comprising:
providing a pair of housing portions with respective pocket portions including wall opening portions and with respective ink blocking shield segments extending across the wall opening portions at inner sides of the housing portions;
mating the housing portions to form a cartridge housing with the pocket portions forming a single pocket including the wall opening portions forming a single wall opening and the ink blocking shield segments abutting edge-to-edge to seal the single wall opening; and
including a memory chip in the single pocket as the single pocket is formed.

10. An ink cartridge comprising a pair of housing halves with respective pocket portions including wall opening portions, an ink supply bag contained in said housing halves, and a memory chip supported in said wall opening portions, is characterized in that:
said housing halves have respective ink blocking shield segments that extend across said wall opening portions at inner sides of said housing halves to prevent any ink that might leak from said bag from entering said wall opening portions and contaminating said memory chip.

11. A pair of housing halves for containing an ink supply bag and provided with respective pocket portions including wall opening portions for a memory chip, are characterized in that:
said housing halves have respective ink blocking shield segments that extend across said wall opening portions at inner sides of said housing halves to prevent any ink that might leak from an ink bag contained in said housing halves from entering said wall opening portions and contaminating a memory chip supported in said wall opening portions.

12. A pair of housing halves as recited in claim 11, wherein said housing halves mate to form a cartridge housing, said pocket portions form a single pocket including said wall opening portions forming a single wall opening when said housing halves mate, and said ink blocking shield segments abut edge-to-edge to seal said single wall opening when said housing halves mate.

13. A pair of housing halves as recited in claim 11, wherein one of said wall opening portions is larger than the other.
